(19) United States
(12) Patent Application Publication
(10) Pub. No.: US 2013/0189402 A1
(43) Pub. Date: Jul. 25, 2013

(54) SYSTEMS AND METHODS FOR MAINTAINING RED MEAT

(71) Applicant: Laurence D. Bell, Mountain View, CA (US)

(72) Inventor: Laurence D. Bell, Mountain View, CA (US)

(73) Assignee: Global Fresh Foods

(21) Appl. No.: 13/601,881

(22) Filed: Aug. 31, 2012

Related U.S. Application Data
(60) Provisional application No. 61/590,756, filed on Jan. 25, 2012.
(60) Provisional application No. 61/607,258, filed on Mar. 6, 2012.
(60) Provisional application No. 61/646,076, filed on May 11, 2012.

(51) Int. Cl. A23B 4/16; B65B 25/06; A23L 1/314

(52) U.S. Cl. 426/129; 426/263; 426/647

(57) ABSTRACT

Disclosed herein are systems, methods and processes for preparing, packaging and preserving red meat, especially maintaining the freshness and color of the meat. In one embodiment, the disclosed method comprises treating the meat with an inert gas followed by replacement of at least a portion of that inert gas with carbon dioxide.

### CROSS-REFERENCE TO RELATED APPLICATIONS

This application claims the benefit under 35 U.S.C. §119 of U.S. Provisional Patent Application Ser. No. 61/590,756, filed on Jan. 25, 2012, U.S. Provisional Patent Application Ser. No. 61/607,258, filed on Mar. 6, 2012, and U.S. Provisional Patent Application Ser. No. 61/646,076, filed on May 11, 2012, each of which is incorporated herein by reference in its entirety.

### TECHNICAL FIELD

This invention relates to systems, methods and processes for preparing, packaging and preserving red meat, especially maintaining the freshness and color of the meat.

### BACKGROUND

The storage-life of oxidatively-degradable meats such as red meat is limited in the presence of a normal atmospheric environment. The presence of oxygen at levels found in a normal atmospheric environment leads to changes in odor, flavor, color, and texture resulting in an overall deterioration in quality of the meat either by chemical effect or by growth of aerobic spoilage microorganisms.

Modified atmosphere packaging (MAP) has been used to improve storage-life and safety of stored red meats by inhibition of spoilage microorganisms and pathogens. MAP is the replacement of some or most of the normal atmospheric environment in a food storage pack with a single inert gas or a mixture of inert gases. The resulting gas in a MAP mixture is most often combinations of nitrogen (N₂) and carbon dioxide (CO₂) with a small amount of oxygen (O₂). In most cases, the bacteriostatic effect is obtained by a combination of decreased O₂ and increased CO₂ concentrations. Farber, J. M. 1991. Microbiological aspects of modified-atmosphere packaging technology: a review. J. Food Protect. 54:58-70.

U.S. Pat. No. 8,187,653 and U.S. Patent Application Publication Nos. 2011/0151070 and 2011/0151084, and International Application WO2011/053676 provide methods and systems of preserving oxidatively-degradable meats in containers, such as totes, having an atmosphere that is low in O₂, and in some embodiments, high in CO₂. These methods and systems have demonstrated uniquely extended shelf life after removal from the “Controlled” atmosphere compared to conventional MAP and Vacuum packaging technologies. Each of these publications is individually incorporated by reference in its entirety.

Notwithstanding the benefits imparted by these methods and systems, red meats often undergo discoloration in a few hours to a few days after packaging. Specifically, red meats, such as ground beef, will quickly turn to a “brownish” color which is perceived by the consumer to be as not fresh.

Without being limited to any theory, discoloration of consumable red meat is caused, in part, by denaturation of the myoglobin protein by spoilage organisms, desiccation and other deteriorative processes. Accordingly, it would be beneficial if methods were developed which would allow for retention of the natural color of red meat.

### SUMMARY OF THE INVENTION

This invention is predicated, in part, on the unexpected discovery that modification of the deoxygenation protocols used to stabilize the freshness of red meat leads to significantly improved color retention in the meat. In particular, the meat is deoxygenated by removing the enclosed oxygen above and around the meat by employing an oxygen remover, such as fuel cell(s) which convert the oxygen in the air to water vapor, leaving an air with an inert gas atmosphere comprising substantially nitrogen, or by removing the enclosed air above and around the meat by using an inert gas, such as nitrogen, prior to the application of CO₂. Depending on the size of the container or tote additional dwell time in the deoxygenation environment may be necessary to complete the deoxygenation process. Deoxygenation is followed by replacement of at least a portion of that inert gas with carbon dioxide which prevents spoilage (under good refrigeration). This non-CO₂ deoxygenation process significantly enhances the color stabilization of red meat. Without being limited to any theory, it is believed that current MAP procedures employing an initial carbon dioxide flush with no deoxygenation pretreatment to maintain freshness of red meat contribute to or at least do not alter the irreversible loss of the red color stability of the meat.

This invention modifies the deoxygenation process by first introducing an inert gas preferably containing no more than 5% v/v carbon dioxide (e.g., nitrogen) to initiate the process. When oxygen levels are adequately reduced, at least a portion of the nitrogen is replaced with carbon dioxide while the oxygen concentration is maintained or continues to be reduced as the nitrogen is replaced.

In one of its method aspects, provided herein is a method to inhibit discoloration of red meat, which method comprises:

(1) reducing the oxygen concentration in the atmosphere of a sealed container containing red meat to no more than about 5% v/v to obtain an inert gas atmosphere,

(2) introducing a sufficient amount of exogenous carbon dioxide into the container while retaining or further reducing the oxygen concentration in the atmosphere of the container so as to inhibit the discoloration of the red meat; and

(3) optionally transferring the red meat into a package which is resistant to gas exchange.

In another of its method aspects, provided herein is a method to inhibit discoloration of red meat, which method comprises

(1) replacing at least a portion of the atmosphere in a sealed container comprising red meat with a nitrogen flush so as to reduce the oxygen concentration to no more than about 5% v/v, and incubating the red meat in the container for a period sufficient to deoxygenate the red meat wherein the nitrogen flush contains no more than about 5% v/v carbon dioxide,

(2) replacing at least a portion of the gas in the atmosphere of the container provided for above with exogenous carbon dioxide; and

(3) optionally transferring the red meat into a package having a carbon dioxide atmosphere which package is resistant to gas exchange.

In another of its method aspects, provided herein is a method to inhibit discoloration of red meat, which method comprises

(1) contacting the red meat with an inert gas atmosphere containing no more than about 5% v/v carbon dioxide for a period of time sufficient to deoxygenate the red meat,

(2) placing the meat in a carbon dioxide atmosphere; and

(3) optionally transferring the red meat into a package having a carbon dioxide atmosphere and limited oxygen permeability.

Optionally, the red meat may be case ready packaged in a gas permeable material that allows gas exchange in and around the red meat such that the deoxygenation process and application of CO₂ are operative for the red meat in these packages inside a master tote having an inert gas atmosphere or carbon dioxide atmosphere. These gas permeable packages may be removed from the master tote allowing for the blooming of the red meat color in air with no additional manipulation of the case ready packaging or with addition of an oxygen comprising gas, such as air or oxygen.

In one of its process aspects, this invention provides an improved process for preparing animal red meat for consumption which comprises at least the steps of slaughtering and butchering and optionally further processing the meat so as to be in a form suitable for storing and/or transporting in either bulk quantities or individual case ready packages in a carbon dioxide environment, wherein the improvement comprises inhibiting discoloration of the meat arising during storage and/or transportation by deoxygenating the meat during at least one step in the process in an inert gas prior to placing the meat in a carbon dioxide atmosphere for storing and/or transporting.

In another of its process aspects, this invention provides an improved process for preparing animal red meat which comprises at least the steps of slaughtering and butchering and optionally further processing the meat so as to be in a form suitable for storing and/or transporting in either bulk quantities or individual case ready packages, wherein the improvement comprises

contacting the red meat in a nitrogen atmosphere containing no more than about 5% v/v carbon dioxide for a sufficient amount of time to deoxygenate during any of the steps of the process as described above;

contacting the red meat with a gaseous composition containing a sufficient amount of carbon dioxide under conditions wherein the discoloration of the red meat is inhibited; and

sealing the meat in a package that has a carbon dioxide atmosphere and limited oxygen permeability.

In yet another of its process aspects, the invention provides an improved process for preparing animal red meat which comprises at least the steps of slaughtering and butchering and optionally further processing the meat so as to be in a form suitable for storing and/or transporting in either bulk quantities or individual case ready packages, wherein the improvement comprises

deoxygenating the meat during at least one step in the process in a nitrogen atmosphere until the oxygen level is no more than about 5% v/v;

replacing at least a portion of the nitrogen with carbon dioxide;

sealing the meat in a package having limited oxygen permeability;

storing or transporting the meat in the package; and

optionally controlling the amount of oxygen in the sealed meat during storage and/or transportation.

In other aspects, provided herein are containers, systems and devices useful in the methods and/or processes.

In another aspect, provided herein is a stabilized animal red meat, wherein said red meat is maintained in a sealed container comprising an atmosphere comprising carbon dioxide and no more than about 1% oxygen.

These and other aspects of the invention is further described in the text that follows.

### DETAILED DESCRIPTION

### Definitions

It is to be noted that as used herein and in the claims, the singular forms “a,” “an” and “the” include plural referents unless the context clearly dictates otherwise. Thus, for example, reference to “a fuel cell” includes one, two or more fuel cells, and so forth.

The term “comprising” is intended to mean that the articles and methods include the recited elements, but do not exclude others. “Consisting essentially of” when used to define articles and methods, shall mean excluding other elements of any essential significance to the intended use. “Consisting of” shall mean excluding more than trace amounts of other elements and substantial method steps.

The term “about” when used before a numerical designation, e.g., temperature, time, amount, and concentration, including range, indicates approximations which may vary by (+) or (−) 15%, 10%, 5% or 1%.

The term “red meat” refers to a meat or fish product comprising more than about 0.05% myoglobin or hemoglobin pigment. Examples of red meat include, but are not limited to, beef, pork, lamb, dark-colored chicken, fish such as tuna, tilapia, and other sea foods.

The term “freshness” refers to a state of a meat that displays characteristics, such as a color, texture and smell, as if it is just produced. Specifically, the bright red color of a red meat is an indication that the meat is fresh. The term “discoloration” refers to an irreversible loss of the color of a pigment that indicates the apparent freshness of a foodstuff comprising the pigment. For example, the bright red color of myoglobin pigment is an indication to many consumers that a red meat is fresh. A red meat product that partially or completely loses the bright red color, for example, by turning to a brownish color, is often perceived by consumers as loss of freshness. Thus, an irreversible loss of the bright red color of the myoglobin pigment is referred to as discoloration.

The term “inert gas” refers to a gas that is non-toxic and does not react with the red meat and is substantially free of oxygen and carbon dioxide. Examples of inert gas include nitrogen, argon, krypton, helium, nitric oxide, nitrous oxide, and xenon.

The term “inert gas atmosphere” refers to an atmosphere in a confined space, such as a sealed container, a meat package, a chamber or tube of a meat processing equipment that comprises an inert gas or a mixture of inert gases, and substantially free of oxygen and carbon dioxide.

The term “carbon dioxide atmosphere” refers to an atmosphere in a confined space, such as a sealed container, a meat package, a chamber or tube of a meat processing equipment that comprises carbon dioxide and optionally an inert gas or a mixture of inert gases, and substantially free of oxygen. In some embodiments, the concentration of carbon dioxide is at least about 40 vol. % or at least about 60 vol. %. In some embodiments, the carbon dioxide atmosphere contains about 60 vol. % carbon dioxide and about 40 vol. % nitrogen. In some embodiments, the carbon dioxide atmosphere comprises at least 90 vol. % carbon dioxide.

The term “carbon dioxide source” refers to a gas source comprising carbon dioxide and optionally an inert gas or a mixture of inert gases, and substantially free of oxygen. In some embodiments, the concentration of carbon dioxide is at least about 40 vol. % or at least about 60 vol. %. In some embodiments, the carbon dioxide source contains about 60 vol. % carbon dioxide and about 40 vol. % nitrogen. In some embodiments, the carbon dioxide source comprises at least 90 vol. % carbon dioxide.

The term “substantially free” when used to refer to an amount of oxygen or carbon dioxide refers to an amount that does not interfere with preservation of the red meat and the color of red meat, for example, an amount that is no more than about 5 vol. %, 1 vol. %, about 0.1 vol. %, or about 0.01 vol. %. In some embodiments, substantially free of oxygen means that the oxygen concentration in the atmosphere is no more than 100, or 10 ppm.

The term “sealed container” refers to a container whose interior is isolated from ambient atmosphere without uncontrolled introduction and/or emission of gas, except gas that may diffuse into and/or out of the container through its wall material. A sealed container may comprise inlets and/or outlets which, when opened, allow controlled introduction and/or emission of gas to or from the container. Thus, a container is considered sealed for the purpose of this invention, if the architecture of the container controls the gas content within the container. In one embodiment, the sealed container does not allow gas exchange with outside of the container. In another embodiment, gas can be introduced into and/or released outside the sealed container under controlled conditions. Simply put, a sealed container is a container designed to prevent ambient atmospheric gas from entering into the container except by diffusion through the container (e.g. diffusion through a flexible plastic sheet). “Ambient atmosphere gas” or “ambient air” refers to gas in the general atmosphere typically comprising about 78% of nitrogen and about 21% of oxygen. A “container” can be a room, a warehouse, a cargo container, a package, a box, a carton, an enclosed space of a meat processing instrument, transport vessel, a tote, rigid container, physical rigid room or a tent, etc. The container can be portable or stationary.

The term “deoxygenation of a red meat” or “deoxygenate of a red meat” refers to reduction of the oxygen contained in and around the red meat.

The term “store”, “storing” or “storage” refers to the act of keeping the red meat, after it is processed and before it is consumed, which includes storing the meat in a warehouse, a transportation vessel, or a store's shelf for sale, etc.

The term “retail cut” or “food service cut” refers to the meat portions that are suitable for sale to consumers in a retail store or for preparing meals for customers by a food service provider, such as a restaurant.

The term “case ready packages” refers to meat packages comprising retail cut or food service cut meat that are prepared by a central processing facility and delivered to retail stores which packages are ready for sale to the consumers without the need for further processing, such as cutting or repackaging.

### Methods

In one aspect, provided herein is a method to inhibit discoloration of red meat, which method comprises

(1) reducing the oxygen concentration in the atmosphere of a sealed container containing red meat without the introduction of exogenous carbon dioxide into the container wherein the oxygen concentration is reduced to a predetermined level to maintain the apparent freshness of red meat, and

(2) introducing exogenous carbon dioxide into the container while retaining or further reducing the oxygen concentration in the atmosphere of the container; and

(3) optionally packaging the red meat into a package having a carbon dioxide atmosphere and limited oxygen permeability.

In another of its method aspects, provided herein is a method to inhibit discoloration of red meat, which method comprises

(1) replacing at least a portion of the atmosphere in a sealed container with a nitrogen flush so as to reduce the oxygen concentration to no more than 5% v/v, and incubate the red meat in the container for a period sufficient to deoxygenate the red meat, and

(2) replacing at least a portion of the atmosphere of the container with exogenous carbon dioxide; and

(3) optionally packaging the red meat into a package having a carbon dioxide atmosphere and limited oxygen permeability.

In some embodiments, provided herein is a method to preserve red meat, which method comprises

(1) reducing the oxygen concentration of the atmosphere of the sealed container to no more than 5% v/v, and incubate the meat in the container for a period sufficient to reach deoxygenation of the meat, and

(2) replacing at least a portion of the atmosphere of the sealed container with a sufficient amount of carbon dioxide, and optionally packaging the meat, so as to maintain the freshness and prevent discoloration of the meat for a period of at least 3 days.

In some embodiments, provided herein is a method to preserve red meat, which method comprises

(1) replacing at least a portion of the atmosphere in the container with a nitrogen flush so as to reduce the oxygen concentration to no more than 5% v/v, and incubate the meat in the sealed container for a period sufficient to reach deoxygenation, and

(2) replacing at least a portion of the atmosphere of the sealed container with a sufficient amount of carbon dioxide, and optionally packaging the meat, so as to maintain the freshness and prevent discoloration of the meat upon return to ambient air after a period of at least 3 days in the atmosphere of the sealed container.

In some embodiments, reduction of oxygen concentration is achieved without reducing the internal gaseous pressure of the container by more than 50%. In some embodiments, reduction of oxygen concentration is achieved without reducing the internal gaseous pressure by more than 25%. In some embodiments, reduction of oxygen concentration is achieved without reducing the internal gaseous pressure by more than 5%. In some embodiments, reduction of oxygen concentration is achieved without reducing the internal gaseous pressure. This avoids excessive pressure differentiation between inside and outside of the container.

In some embodiments of the methods disclosed herein, in step (1), the oxygen concentration in the atmosphere of the container is reduced by operation of an oxygen removers, such as a fuel cell or an oxygen adsorber, which removes oxygen and are in gaseous communication with the container.

In some embodiments of the methods disclosed herein, in step (1), the oxygen concentration in the atmosphere of the container is reduced by replacing the oxygen or ambient air with an inert gas. In some embodiments, the inert gas comprises argon, helium, and/or nitrogen, and comprises no more than 1 vol. % of carbon dioxide. In some embodiments, the inert gas comprises no carbon dioxide. In some embodiments, the inert gas is selected from the group consisting of nitrogen, helium and argon. In some embodiments, the inert gas is nitrogen.

In some embodiments, the container comprises plumbing valves and fittings for use to flush the container with the inert gas to replace the oxygen in step (1) and/or to flush the container with carbon dioxide to replace the inert gas in step (2). The inert gas or carbon dioxide used to flush the container is introduced from an inlet, the gas in the container that is replaced by the inert gas or carbon dioxide flush is released through an outlet. After the flush, the inlet and outlet are closed to maintain the atmosphere obtained by the flush.

Gas flush and oxygen remover, such as fuel cell, operation can be done independently or in combination. In some embodiments, the container is flushed prior to turning on the oxygen remover, such as fuel cell. In some embodiments, the container is flushed while the oxygen remover, such as fuel cell is in operation to remove oxygen. The oxygen remover, such as fuel cell, may continue to remove oxygen during the transportation and/or storage. In some embodiments, the oxygen remover independently removes oxygen with no introduction of gas until deoxygenation is accomplished.

In some embodiments, the meat is added to the container before step (1) of the methods disclosed herein. In some embodiments, the meat is added to the container after the oxygen concentration is reduced or the portion of the atmosphere of the container is replaced with a nitrogen flush step (1) of the methods disclosed herein.

In some embodiments of the methods, in step (1), the oxygen concentration in the atmosphere of the sealed container is reduced to less than about 5 vol. %, 4 vol. %, 3 vol. %, 2 vol. % or 1 vol. %. In some embodiments, the oxygen concentration in the atmosphere of the sealed container is reduced to less than 0.1 vol. %. In some embodiments, the oxygen concentration in the atmosphere of the sealed container is reduced to less than 0.01 vol. %. In a preferred embodiment, in step (1), an inert gas atmosphere is produced inside the sealed container, and in step (2), a carbon dioxide atmosphere is produced inside the sealed container.

In some embodiments of the methods, the meat is incubated in the atmosphere of step (1) for at least about 1 hour before step (2) when the portion of the atmosphere is replaced with carbon dioxide. In some embodiments, the meat is incubated in the atmosphere of step (1) for at least 2 hours, 5 hours, 7 hours or at least 12 hours before step (2) when the portion of the atmosphere is replaced with carbon dioxide.

In some embodiments of the methods, in step (2), the oxygen concentration in the atmosphere of the sealed container is further reduced to less than 1500 ppm, by for example, replacing the oxygen with carbon dioxide and/or operation of the fuel cell.

In some embodiments of the methods, in step (2), at least about 60 vol. percent of the atmosphere in the container is replaced with carbon dioxide or a low oxygen gas comprising carbon dioxide. In some embodiments, the low oxygen gas is a mixture of CO₂ and nitrogen or other inert gas, for example, a mixture of 60 vol. % CO₂ and 40 vol. % nitrogen. In one embodiment, the carbon dioxide or the low oxygen gas contains less than 100, or 10 ppm oxygen. In some embodiments of the methods, in step (2), at least 90 vol. percent of the atmosphere in the container is replaced with carbon dioxide. In some embodiments, the atmosphere of the container comprises at least 60 vol. percent carbon dioxide after completion of step (2). In some embodiments, the atmosphere of the container comprises at least 90 vol. percent carbon dioxide after completion of step (2).

In another of its method aspects, provided herein is a method to inhibit discoloration of red meat, which method comprises

(1) placing the meat in an inert gas atmosphere for a period of time sufficient to deoxygenate the red meat, and

(2) placing the meat in a carbon dioxide atmosphere; and

(3) optionally packaging the meat into a package having a carbon dioxide atmosphere and limited oxygen permeability.

In some embodiments, the period of time in step (1) is at least about 1 hour. In some embodiments, the period of time in step (1) is at least 2 hours, 5 hours, 7 hours or at least 12 hours.

Preferably the gas used in the methods is acceptable by the relevant regulatory agencies, such as the U.S. Food and Drug Administration (FDA) “GRAS” (Generally Recognized as Safe) food grade carbon dioxide and nitrogen.

It should be understood that one source of oxygen in certain food stuffs is its release from hemoglobin. In such a case, carbon monoxide interacts with and binds more strongly to the hemoglobin than oxygen. Accordingly, for the purposes of this invention, carbon monoxide is considered not to be an inert gas.

In some embodiments of the methods, the container is a tote comprising a flexible, collapsible or expandable material with limited oxygen permeability which does not puncture when collapsing or expanding. The tote can withstand or volumetrically compensate for, the internal pressure loss such as carbon dioxide absorption by the meat, or pressure gain, such as reduction of barometric pressure during transport and/or shipment.

In some embodiments, the tote comprises an initial headspace that compensates for such absorption permitting the oxygen concentration in the tote to be maintained at a desired level and/or without creating a vacuum condition. In some embodiments, the initial headspace occupies at least 30 or at least 40 volume percent of the tote. In some embodiments, the initial headspace occupies about 50 volume percent of the tote. In one embodiment, the headspace is about or at least 69 vol. percent of the tote. In some embodiments, the initial headspace is from about 30% to about 95% the internal volume of the tote. In other embodiments, the initial headspace is from about 35% to about 40% of the internal volume of the tote, or alternatively, the initial headspace is about 30% to about 35% of the internal volume of the tote, or alternatively, the initial headspace is about 35% of the internal volume of the tote.

In some embodiments, the vertical architecture of the tote facilitates minimizing horizontal space requirements for shipping the maximum number of pallets side-by-side. Embodiments that spread the headspace out horizontally may not be as economically viable at a large scale in addition to not enjoying the leak resistance as long as the headspace remains positive. In certain embodiments, no more than about 20% of the expansion of the tote is in the horizontal direction, with the remainder of the gaseous expansion being in the vertical direction thus creating the “head pressure” and headspace height of the tote. The tote is configured to expand in a vertical manner creating an initial “head pressure” after the carbon dioxide flush. Initial tote head pressures can range from about 0.1 to about 1.0 inches of water column or more above atmospheric pressure. The flexible tote can be made more flexible in the vertical direction than in the horizontal by conventional methods, such as using more flexible material in the vertical direction.

In some embodiments, the totes are able to accommodate a sufficient headspace such that the tote would require no continuous oxygen monitoring and/further periodic gas flushing after the atmosphere of the tote is replaced with a sufficient amount of carbon dioxide in step (2). In some embodiment, the gas flushes with carbon dioxide in step (2) can proceed periodically for up to 72 hours, for example, 60 hours, or alternatively, 48 hours, or alternatively, 24 hours, after step (1). Alternatively, the initial gas flushes can proceed during the first 72 hours or less, or alternatively, the first 60 hours, or alternatively, the first 48 hours, or alternatively, the first 24 hours, after start of step (2).

In some embodiments, the container is a rigid room or container. When the container is a rigid room or container, after step (2), an inert gas, such as nitrogen, or carbon dioxide can be introduced continuously or intermittently as needed to the room or container to compensate for gas absorption by the meat and keep the oxygen concentration at a desired low level until the meat is released for distribution. Alternatively, an oxygen remover may be operated continuously or intermittently to keep the oxygen concentration at a desired low level.

In some embodiment, the meat is transferred to a different container having a carbon dioxide atmosphere after it is deoxygenated, i.e., the container in step (1) is different from the container in step (2). The meat is stored and/or transported in the second container.

In some embodiment, after deoxygenation and treatment with carbon dioxide, the meat is further packaged in a smaller package, such as a case ready package, having a carbon dioxide atmosphere and limited oxygen permeability, in which it is transported and/or stored.

In some embodiments, the red meat may be case ready packaged, for example, prior to deoxygenation, in a gas permeable material that allows gas exchange in and around the red meat such that the deoxygenation process and application of CO₂ are operative for the red meat in these packages inside a master tote having an inert gas atmosphere or carbon dioxide atmosphere. Preferably, the case ready package is in the inert gas atmosphere for a sufficient amount of time to allow deoxygenation in and around red meat, such as at least 1 hour, 2 hours, 3 hours, 6 hours, 12 hours, or one day. After deoxygenation, the case ready package is placed in the carbon dioxide atmosphere for transportation and/or storage. These gas permeable packages may be removed from the master tote allowing for the blooming of the red meat color in air with no additional manipulation of the case ready packaging or with addition of an oxygen containing gas, such as air or oxygen. Gas permeable materials suitable for meat packaging are known in the art, for example, cellulose, polyethylene, polypropylene, microperforated materials/films, etc.

In some embodiments of the methods, the meat is red meat. In some embodiments, the meat is beef, lamb or pork. In some embodiments, the meat is fish comprising the myoglobin pigment or hemoglobin pigment. In some embodiments, the meat is tilapia. In some embodiments, the meat is tuna, mackerel and other seafoods.

The methods can be used in the transporting or storing the meat in the carbon dioxide atmosphere in either the initial container, or a different container, such as a sealed case ready package, for a time periods in excess of 100 days. In some embodiments of the methods, the transportation and/or storage is for a time period of at least 3 days. In some embodiments, the transportation and/or storage is for a time period of at least 5, 10, 15, 30, or 45 days.

Oxygen may accumulate in the container during transportation and/or storage by, for example, diffusion into the container through the material of limited oxygen permeability or at the seal of the container. Oxygen may also be released by the meat within the container or from containers in which the meat is packaged. In some embodiments, the oxygen concentration of the atmosphere of the containers is maintained at or below 1500 ppm during the transportation and/or storage by, for example, operation of the one or more fuel cells or additional flushes with a gas comprising an inert gas and/or carbon dioxide. The removal of oxygen can be performed continuous or periodically. If performed periodically, the removal of oxygen can be pre-programmed according to a schedule or triggered by a preset oxygen concentration in the container.

### Processes

In another aspect, this invention provides an improved process for preparing red meat for consumption which comprises at least the steps of slaughtering and butchering and optionally further processing the meat so as to be in a form suitable for storing and/or transporting in either bulk quantities or individual case ready packages in a carbon dioxide environment, wherein the improvement comprises deoxygenating the meat in an inert gas during at least one step in the process prior to placing the meat in a carbon dioxide atmosphere for storing and/or transporting.

In another aspect, this invention provides an improved process for preparing red meat which comprises at least the steps of slaughtering and butchering and optionally further processing the meat so as to be in a form suitable for storing and/or transporting in either bulk quantities or individual case ready packages, wherein the improvement comprises placing the meat in a nitrogen atmosphere for a sufficient amount of time to deoxygenate during the process;

placing the meat in a carbon dioxide atmosphere;

sealing the meat in a package that has a carbon dioxide atmosphere and limited oxygen permeability; and

storing or transporting the meat in the packaging.

In another aspect, the invention provides an improved process for preparing red meat which comprises at least the steps of slaughtering and butchering and optionally further processing the meat so as to be in a form suitable for storing and/or transporting in either bulk quantities or individual case ready packages, wherein the improvement comprises

deoxygenating the meat during at least one step in the process in a nitrogen atmosphere until the oxygen level is less than 5 vol. percent;

replacing at least a portion of the inert gas with carbon dioxide;

sealing the meat in a package that has limited oxygen permeability;

storing and/or transporting the meat; and

optionally controlling the amount of oxygen in the sealed package during storage and/or transportation.

The improvement by the deoxygenation-carbon dioxide method and other aspects or embodiments thereof described herein (also referred to as method of deoxygenation and subsequent carbon dioxide application) can be used in any process for producing uncooked red meat products for consumption. The following are few examples of how the improvement can be applied to certain processes. The invention is not intended to be limited to these examples.

### 1. Single Source Production, Slaughter, Retail (Food Service) Cut and (Case Ready) Package

A live, healthy muscle food producing animal (e.g. beef cattle, pigs, sheep, lamb, fish, deer, etc.) is slaughtered, butchered, and optionally further cut into retail or food service cuts or ground. The meat is hygienically chilled after being butchered or after being cut into retail and food service cuts or ground. The cut or ground meat is packaged (e.g., in case ready packages) or otherwise supported and consolidated.

During any of the above steps, the meat can be deoxygenated in an inert gas, such as nitrogen, atmosphere prior to being introduced into and preserved in a carbon dioxide atmosphere. For example, during or after the meat is butchered or cut into retail or food service cuts or ground, the meat can be deoxygenated by placing the meat in an inert gas atmosphere for a sufficient amount of time. This can be done simultaneously with cutting and/or chilling. The meat can be turned or stirred to facilitate deoxygenation. The deoxygenated meat is then placed in a carbon dioxide atmosphere or packaged in a package having a carbon dioxide atmosphere and limited oxygen permeability for storage and/or transportation.

In some embodiments, the red meat may be case ready packaged, for example, prior to deoxygenation, in a gas permeable material that allows gas exchange in and around the red meat such that the deoxygenation process and application of CO₂ are operative for the red meat in these packages inside a master tote having an inert gas atmosphere or carbon dioxide atmosphere. These gas permeable packages may be removed from the master tote allowing for the blooming of the red meat color in air with no additional manipulation of the case ready packaging or with addition of an oxygen containing gas, such as air or oxygen. Gas permeable materials suitable for meat packaging are known in the art, for example, cellulose, polyethylene, polypropylene material, etc.

Alternatively, deoxygenation can be conducted after packaging to adequately remove oxygen before introducing carbon dioxide. This process may employ packaging element that is gas permeable to varying degrees or supporting matrices that allow gas exchange. Gas-impermeable packaging may also be designed to allow deoxygenation followed by carbon dioxide application. For example, the package can have an inlet and/or outlet for gas exchange, such as described in the “Systems” section below. After a sufficient time to allow deoxygenation with an inert gas and subsequent induction of carbon dioxide for a period of time and in an amount sufficient to accommodate carbon dioxide absorption, the inlet and/or outlet is sealed to maintain a carbon dioxide atmosphere inside the package. Preferably, after sealing the individual package, no external carbon dioxide atmosphere is required for further storage or transport.

During storage or transport, the packages are unitized so as to keep the meat in the carbon dioxide atmosphere. The packages can be loaded into cartons or other containers for distribution to end users. In some embodiments, the method of deoxygenation and subsequent carbon dioxide application is performed after the packages are loaded in the cartons. The cartons can be designed to facilitate gas exchange (e.g. deoxygenation by an inert gas and subsequent carbon dioxide application). Separators between individual packages (or other ways) may be employed to enhance gas exchange around and into each package.

Alternatively, the packages can be stacked in or on other supporting matrices that optimize cube and gas exchange for the deoxygenation and subsequent carbon dioxide application. In some embodiments, packages are further unitized for loading into a system described herein. In some embodiments, the method of deoxygenation and subsequent carbon dioxide application is performed after the packages are loaded in said system, for example, as described herein. The packages are stored and/or transported in the system having a carbon dioxide atmosphere until being taken out of the system for further distribution in air.

In some embodiments, the packages are contained in a portable or stationary tote, rigid container or physical rigid room or a large sealable stationary tent. In some embodiments, the tent is a sealable tent, which is optionally used on a sufficiently equipped transport vessel. In some embodiments, the method of deoxygenation and subsequent carbon dioxide application is performed after the packages are contained inside a portable or stationary tote, rigid container or physical rigid room or a large sealable stationary tent. The packages are stored and/or transported in the portable or stationary tote, rigid container or physical rigid room or the large sealable stationary tent having a carbon dioxide atmosphere until taken out of the portable or stationary tote, rigid container or physical rigid room or the large sealable stationary tent for further distribution in air.

### 2. Separate Slaughter & Butcher Location From Further Retail (Food Service) Cuts and (Case Ready) Packaging.

In this example slaughter and butchering may be conducted at separate locations.

A live, healthy muscle food producing animal (e.g. beef cattle, pigs, sheep, lamb, fish, deer, etc.) is slaughtered and butchered. The meat is hygienically chilled after being butchered. “Sub-primal” cuts or retail and food service cuts or ground meat are produced for transport to another location. The cut meat is packaged (e.g., in case ready packages) or otherwise supported and consolidated.

Traditionally, these “sub-primal” cuts are vacuum packaged. The method of deoxygenation and subsequent carbon dioxide application can be performed after the meat is cut and being packaged, or after it is loaded directly into a transportation vessel or loaded in packages which are then loaded onto a transportation vessel. For example, the sub-primal cuts is placed in an inert gas, such as nitrogen, atmosphere for a sufficient amount of time to deoxygenate completely, or at least partially where the meat cut is large in size, for example, the surface area and a sufficient depth beneath the surface area of the meat, and then placed and packaged in a carbon dioxide atmosphere or loaded into a transportation vessel having a carbon dioxide atmosphere.

In another embodiment, the air inside the transportation vessel or the packaging can be replaced with an inert gas and the meat is being incubated in the inert gas for a sufficient amount of time to deoxygenate the meat completely or partially. Upon sufficient deoxygenation, at least part of the inert gas is replaced with carbon dioxide and the meat is transported in the carbon dioxide atmosphere.

Alternatively, deoxygenation can be conducted after packaging to adequately remove oxygen before introducing carbon dioxide. This process may employ packaging that is gas permeable to varying degrees or supporting matrices that allow gas exchange. Gas-impermeable packaging may also be designed to allow deoxygenation followed by carbon dioxide application. For example, the package may have an inlet and/or outlet for gas exchange, such as described in the “Systems” section above. The inlet and/or outlet can be sealed after a sufficient time to allow deoxygenation with an inert gas before induction of carbon dioxide, and a sufficient time to accommodate carbon dioxide absorption after introduction of carbon dioxide. Preferably, after the individual packages are sealed, no external carbon dioxide atmosphere is required for further storage or transport.

During storage or transport, the packages are unitized so as to keep the meat in the carbon dioxide atmosphere. The packages can be loaded into cartons or other containers for distribution to end users. In some embodiments, the steps of deoxygenation and subsequent carbon dioxide introduction are performed after the packages are loaded in the cartons. The cartons can be designed to facilitate gas exchange (e.g. deoxygenation by an inert gas and subsequent carbon dioxide introduction). Separators between individual packages (or other ways) may be employed to enhance gas exchange around and into each package.

Alternatively, the packages can be stacked in or on other supporting matrixes that optimize cube and gas exchange for the deoxygenation and subsequent carbon dioxide introduction. In some embodiments, packages are further unitized for loading into a system described herein. In some embodiments, the method of deoxygenation and subsequent carbon dioxide introduction are performed after the packages are loaded in said system. The packages are stored and/or transported in the system having a carbon dioxide atmosphere until being taken out of the system for further distribution in air.

In some embodiments, the packages or supported/consolidated sub-primal cuts are contained in a portable or stationary tote, rigid container or physical rigid room or a large sealable stationary tent. In some embodiments, the tent is a sealable tent, which is optionally used on a sufficiently equipped transport vessel. In some embodiments, the method of deoxygenation and subsequent carbon dioxide application is performed after the packages are contained inside a portable or stationary tote, rigid container or physical rigid room or a large sealable stationary tent. After sufficient deoxygenation, the packages are stored and/or transported in the portable or stationary tote, rigid container or physical rigid room or large sealable stationary tent having a carbon dioxide atmosphere until being taken out for further distribution in air.

In some embodiments, the sub primal-cut meat is distributed to a local distribution center or a retail store.

At this point the sub-primal cuts that have been stored and/or transported in the carbon dioxide atmosphere may be further cut into retail (case ready) or food service cuts or ground and hygienically chilled, if necessary. The further cut meat can be packaged, for example, in case ready packages, or otherwise supported and consolidated. The method of deoxygenation and subsequent carbon dioxide application can be performed before or after the meat is packaged or otherwise supported and consolidated.

If the method of deoxygenation and subsequent carbon dioxide application is performed after the meat is packaged or otherwise supported and consolidated, packaging and supporting/consolidation materials and equipment that facilitate adequate removal of oxygen and introduction of carbon dioxide are used. In some embodiments, the packaging material or supporting matrices are gas permeable to varying degrees to allow gas exchange.

In some embodiments, impermeable packaging may be designed to allow deoxygenation followed by carbon dioxide application. For example, the package may have an inlet and/or outlet for gas exchange, such as described in the “Systems” section above. After a sufficient time to allow deoxygenation with an inert gas and subsequent application of carbon dioxide in a time and amount sufficient to accommodate carbon dioxide absorption, the inlet and/or outlet are sealed to maintain a carbon dioxide atmosphere inside the packages. Preferably, after sealing the individual packages, no external carbon dioxide atmosphere is required for further storage or transport.

During storage or transport, the packages are unitized so as to keep the meat in the carbon dioxide atmosphere. The packages can be loaded into cartons or other containers for distribution to end users. In some embodiments, the method of deoxygenation and subsequent carbon dioxide application is performed after the packages are loaded in the cartons. The cartons can be designed to facilitate gas exchange (e.g. deoxygenation by an inert gas and subsequent carbon dioxide application). Separators between individual packages (or other ways) may be employed to enhance gas exchange around and into each package.

Alternatively, the packages can be stacked in or on other supporting matrixes that optimize cube and gas exchange for the deoxygenation and subsequent carbon dioxide introduction. In some embodiments, packages are further unitized for loading into a system described herein. In some embodiments, the method of deoxygenation and subsequent carbon dioxide application is performed after the packages are loaded in said system. The packages are stored and/or transported in the system having a carbon dioxide atmosphere until reaching the end point.

### 3. Deoxygenation and Subsequent Application of Carbon Dioxide During Meat Cutting

In this aspect, the deoxygenation is performed simultaneously with meat cutting or grinding. In some embodiments, there is provided a method for preparing cut or ground red meat which method comprises cutting or grinding the meat, placing the cut or ground meat in an inert gas atmosphere for a period of time sufficient to deoxygenate the meat, placing and packaging the meat in a carbon dioxide atmosphere, storing and/or transporting the meat in the package having the carbon dioxide atmosphere. In some embodiments, the inert gas atmosphere comprises nitrogen. In some embodiments, the meat is moved from the point of cutting or grinding to the carbon dioxide atmosphere by a conveyor belt wherein the conveyor belt is in an inert gas atmosphere. In some embodiments, the meat is being turned, agitated or stirred while in the inert gas atmosphere. In some embodiments, a stream of inert gas is injected periodically or constantly to the meat to facilitate deoxygenation. In some embodiments, the meat is placed in the carbon dioxide atmosphere for a period of time sufficient for the meat to absorb carbon dioxide before being packaged in a carbon dioxide atmosphere.

In one embodiment, the meat is fed to a device for cutting and/or grinding the meat. In one embodiment, the cutting and/or grinding device is contained in a sealed room or container having an inert gas atmosphere. The device cuts and/or grinds the meat in the inert gas atmosphere so that deoxygenation occurs during cutting or grinding, and preferably at a reduced temperature, for example, −2° C. to 2° C., to chill the meat. To ensure adequate deoxygenation, the meat stays inside room or container for a sufficient period of time, optionally being turned, agitated or stirred constantly or periodically to maximum exposure of different parts of the meat to the inert gas to facilitate deoxygenation. A stream of the inert gas, such as nitrogen, can be injected to the meat constantly or periodically to facilitate deoxygenation. The amount of meat is controlled to ensure sufficient deoxygenation. In some embodiments, the meat is placed onto a conveyor belt that moves the meat from the point where the meat is cut or ground to another point, such as to the exit of the room having the inert gas atmosphere or to a packaging device where the meat is packaged or otherwise supported or consolidated under a carbon dioxide atmosphere. Alternatively, the conveyor belt moves the meat to another sealed room or container having a carbon dioxide atmosphere to allow absorption of carbon dioxide to the meat before it is packaged or otherwise supported or consolidated. The speed of the conveyor belt can be adjusted based on the size and/or amount of the meat to ensure adequate deoxygenation. The sealed room or container either contains an inert gas source, such as a nitrogen source, or is in gaseous communication with an inert gas source, such as a nitrogen source, so that the oxygen concentration inside the room or container is kept below a desired level, such as about 1 vol. %, about 0.1 vol. % or about 0.01 vol. % etc.

In another embodiment, the cutting and/or grinding device comprises a tube having a conveyor belt inside the tube. The tube is made of an oxygen impermeable material and is in gaseous communication with an inert gas source, such as a nitrogen source, so that there is an inert gas atmosphere inside the tube. In some embodiments, the oxygen concentration inside the tube is kept below a desired level, such as about 1 vol. %, about 0.1 vol. % or about 0.01 vol. % etc. Optionally, the tube is at a reduced temperature, for example, −2° C. to 2° C., to chill the meat. Meat is cut or ground by the cutting and/or grinding device and sent to the tube. The conveyor belt inside the tube moves the meat while the meat is being deoxygenated. The speed of the conveyor belt can be adjusted based on the size and/or amount of the meat to ensure adequate deoxygenation. The amount of meat can also be controlled. The meat can be turned, agitated or stirred constantly or periodically while on the conveyor belt so that different parts of the meat is exposed to the inert gas to facilitate deoxygenation. A stream of the inert gas, such as nitrogen, can be injected to the meat constantly or periodically to facilitate deoxygenation. The amount of meat is controlled to ensure sufficient deoxygenation. The meat is moved by the conveyor belt to a place where it is packaged or otherwise supported or consolidated under a carbon dioxide atmosphere. Alternatively, the conveyor belt moves the meat to another part of the device having a chamber with having a carbon dioxide atmosphere to allow absorption of carbon dioxide to the meat before it is packaged or otherwise supported or consolidated. Still alternatively, the conveyor belt moves the meat to a sealed room or container having a carbon dioxide atmosphere to allow absorption of carbon dioxide to the meat before it is packaged or otherwise supported or consolidated.

### Systems

In another aspect, provided herein is a system useful in the methods of this invention to prepare, transport and/or store red meat.

In some embodiments, the system comprises one or more sealable containers comprising the meat. In some embodiments, the system further comprises one or more oxygen removers, such as fuel cells. The containers are in gaseous communication with one or more of oxygen removers internal or external to the containers. One oxygen remover may be in gaseous communication with one or multiple containers. Multiple containers may share one or more oxygen removers external to the containers. When the oxygen remover is one or more fuel cells, the system optionally further comprises one or more hydrogen sources for operation of the fuel cells to remove oxygen. In some embodiments, the system further comprises a fan. In some embodiments, the fan is powered by the fuel cell. In some embodiments, the fan is powered by another power source. In some embodiments, the system further optionally comprises a holding element suitable for maintaining a hydrogen source internal or external to the container. The holding element for the hydrogen source in the container preferably is a box or bladder configured to hold the hydrogen source and, in some embodiments, the fuel cell. Oxygen removers, including fuel cells, and hydrogen sources are known in the art, examples of which are described in US Patent Application Publication Nos. 2008/0003334, 2011/0151070 and 2011/0151084, and International Application WO2011/053676, the content of which are incorporated by references in their entirety.

In some embodiments, the system further comprises an inert gas source for providing the inert gas to replace the oxygen in the container in step (1) of the methods provided herein. In some embodiments, the inert gas comprises argon, helium, and/or nitrogen, and comprises no more than 1 vol. %, or no more than 0.1 vol. % of carbon dioxide. In some embodiments, the inert gas comprises no carbon dioxide.

The system optionally further comprises a carbon dioxide source (including a gas source providing a low oxygen gas as described which comprises an inert gas and carbon dioxide, such as a gas comprising at least 60% carbon dioxide and remainder is an inert gas, such as nitrogen) for providing carbon dioxide to replace at least a portion of the atmosphere in the container in step (2) of the methods provided herein.

In some embodiments, the container may contain at least one inlet controlled by a valve. During step (1) of the methods provided herein, the inlet may be connected to a source of an inert gas and allows the inert gas to enter into the container to replace at least a portion of the atmosphere of the container that contains oxygen. During step (2) of the methods provided herein, the inlet is connected to a carbon dioxide source and allows carbon dioxide to enter into the container to replace at least a portion of atmosphere of the container containing a reduced concentration of oxygen. The inert gas source and the carbon dioxide source can be any gas source that can provide to the inlet the inert gas or carbon dioxide, respectively, such as a gas cylinder or bladder containing the gas. The inlet is closed when the carbon dioxide concentration in the container is sufficient to preserve the meat contained in the container for a desired amount of time so as to maintain the atmosphere of the sealed container. The inlet used in step (1) and step (2) may be the same or different.

The container may further comprise at least one outlet controlled by a valve which allows the gas inside the container to escape when the inert gas or carbon dioxide is introduced to the container in step (1) or step (2), respectively. In some embodiments, the outlet is connected to one or more oxygen removers, such as fuel cells, and then to one or more of the inlets. In these embodiments, the gas inside the container flushed out by the inert gas is passed through the one or more fuel cells to remove the oxygen from the gas. The gas with oxygen removed can be an inert gas source and is then reintroduced to the container through the inlet that is connected to the one or more oxygen removers.

In some embodiments, the container is a rigid room or container described herein.

In some embodiments, the container is a tote comprising a flexible, collapsible or expandable material having limited oxygen permeability.

Materials resistant to gas exchange or of limited oxygen permeability that can be used in certain containers, such as a tote or a case ready meat package, preferably have a gas transmission rate or an oxygen transmission rate (OTR), respectively, of less than 10 cubic centimeters/100 square inch/24 hours/atm, less than 5 cubic centimeters/100 square inch/24 hours/atm, less than 2 cubic centimeters/100 square inch/24 hours/atm; or less than 1 cubic centimeters/100 square inch/24 hours/atm. Materials that can be used are shown in Table 1.

TABLE 1

| | Moisture Vapor | Oxygen |
|---|---|---|
| | Transmission Rate | Transmission Rate |
| | (MVTR) (gm/100 sq. | OTR (c.c./100 sq. |
| MATERIAL | in./24 hours) | in./24 hours/atm) |
| Saran 1 mil | 0.2 | 0.8-1.1 |
| Saran HB 1 mil | 0.05 | 0.08 |
| Saranex 142 mil | 0.2 | 0.5 |
| Aclar 33C .75 mil | 0.035 | 7 |
| (military grade) | | |
| Barex 210 1 mil | 4.5 | 0.7 |
| Polyester 48 Ga. | 2.8 | 9 |
| 50 M-30 Polyester Film | 2.8 | 9 |
| 50 M-30 PVDC Coated | 0.4 | 0.5 |
| Polyester | | |
| Metallized Polyester 48 Ga. | 0.05 | 0.08-0.14 |
| Nylon 1 mil | 19-20 | 2.6 |
| Metallized Nylon 48 Ga. | 0.2 | 0.05 |
| PVDC-Nylon 1 mil | 0.2 | 0.5 |
| 250 K Cello | 0.5 | 0.5 |
| 195 MSBO Cello | 45-65 | 1-2 |
| LDPE 2 mil | 0.6 | 275 |
| Opp .9 mil | 0.45 | 80 |
| EVAL, Biax 60 Ga. | 2.6 | 0.03 |
| EVAL EF-E 1 mil | 1.4 | 0.21 |
| EVAL EF-F 1 mil | 3.8 | 0.025 |
| Benyl H 60 Ga | 0.7 | 0.4 |
| PVC 1 mil | 4-5 | 8-20 |
| Polycarbonate 1 mil | 9 | 160 |
| Polystyrene 1 mil | 7.2 | 4.800 |
| Pliofilm 1 mil | 1.7 | 660 |

The container and/or the system may further comprise a temperature control system, such as cooling system, for maintaining a temperature of the container sufficient to preserve the color and freshness of the meat. Such temperatures would depend on the nature of the meat, and can be determined by one of skill in the art. The temperature is generally maintained in a range of about 0-3.3° C., a range of 0-2° C., or a range of 0-1° C. or −2-0° F. Variation in the temperature is allowed as long as the temperature is maintained within a range to preserve the meat and the color of the pigment.

The container optionally contains monitors to monitor, indicate and/or record oxygen levels, hydrogen levels, fuel cell operation, and temperature, etc. Such monitors are known in the art. The system optionally further comprises a visible indicator, such as an LED light, which indicates problems of any of the devices so that the problematic device can be replaced. Such monitors and indicators may be contained in a box.

In some embodiments, the unitized packaging system mentioned herein is a unitized packaging system, including unitized packaging elements, described in U.S. Patent Application No. 13/______, entitled “Packages and methods for storing and transporting perishable foods” (Attorney Docket 072801-1350), filed on even date, the content of which is incorporated by reference in its entirety.

The system or containers can be configured so as to be suitable for transporting and/or storing in a shipping freighter or be used in a meat processing plant or facility. A shipping freighter means any vessel that can be used to transport and/or store the system including, but not limited to, an ocean shipping freighter, a trucking shipping freighter (such as a tractor-trailer), a railroad car, and an airplane capable of transporting cargo load. One or more containers can be used in a single shipping freighter and each can be configured to have a different gaseous environment as well as a different meat. The containers can be delivered to the same or different site(s). The size of each container can be different. The containers may hold as little as a few ounces of meat to as much as, or greater than, 50,000 pounds, or tons of meat. In some embodiments, the container can hold about 500 pounds, about 1000 pounds, or about 2000 pounds of meat. Large containers may contain multiple smaller containers, such as case ready packages. The number of packaging modules per system depends both on the size of the shipping freighter used to transport and/or store the meat and the size of the containers.

In another aspect, provided herein is a stabilized animal red meat, wherein said red meat is maintained in a sealed container comprising an atmosphere comprising carbon dioxide and no more than about 1% oxygen. In some embodiments, the atmosphere comprises no more than about 1500 ppm oxygen. In some embodiments, the atmosphere is an atmosphere obtained after step (2) of the methods described herein. In some embodiments, the red meat has a fresh appearance when exposed to ambient atmosphere. In some embodiments, the red meat is maintained for a period described herein. In some embodiments, the red meat is a red meat described herein. In some embodiments, the red meat is beef, pork, lamb or dark-colored chicken. In some embodiments, the red meat is tilapia, tuna, or mackerel.

### EXAMPLE

The following description sets forth a specific embodiment of the invention disclosed herein. The specific embodiment is but one of the possible configurations and uses of the present invention and should not be construed in any manner as a limitation of the invention.

Tilapia fillets were stored in the following example. Tilapia fillets contain “blood lines” with a bright red color due to the presence of myoglobin pigment. If upon storage, the myoglobin becomes irreversibly discolored, the blood lines of the tilapia fillets would lose the bright red color and the fish would not appear fresh.

To each of the two containers, Container 1 and Container 2, was placed about 1 metric ton of fresh chilled tilapia fillets packaged in 60 boxes per container (and average of 112 fillets per box) at about 32° F. (0° C.) in Canas, Costa Rica. Container 2 was initially flushed with nitrogen with simultaneous fuel cell operation to remove oxygen. Container 1 was initially flushed with carbon dioxide with simultaneous fuel cell operation to remove oxygen. The oxygen concentration in both containers reached below 0.5% at the end of the initial flush. The containers were kept for 11 to 12 hours at which time the oxygen concentration rose to just under about 1% in both containers. Both containers were then flushed with carbon dioxide until the oxygen concentration was below 0.1%. The containers were held for 30 days. At the end of the 30 day period, the containers were opened and the tilapia fillets inside the containers were observed for freshness. The tilapia fillets in Container 2 had bright red blood lines and were indistinguishable in all aspects from tilapia fillets that were just prepared. The blood lines of the tilapia fillets in Container 1 became a brown color which made the fish look unfresh.

What is claimed is:

1. A method to inhibit discoloration of red meat, which method comprises:
(a) reducing the oxygen concentration in the atmosphere of a sealed container containing red meat to no more than about 5% v/v to obtain an inert gas atmosphere,
(b) introducing a sufficient amount of exogenous carbon dioxide into the container while retaining or further reducing the oxygen concentration in the atmosphere of the container so as to inhibit the discoloration of the red meat; and
(c) optionally transferring the red meat into a package with limited gas permeability.

2. A method to inhibit discoloration of red meat, which method comprises
(a) replacing at least a portion of the atmosphere in a sealed container comprising red meat with a nitrogen flush so as to reduce the oxygen concentration to no more than about 5% to obtain an inert gas atmosphere, and incubating the red meat in the inert gas atmosphere for a period sufficient to deoxygenate the red meat wherein the nitrogen flush contains no more than about 5% v/v carbon dioxide,
(b) replacing at least a portion of the gas in the atmosphere of the container provided for above with exogenous carbon dioxide; and
(c) optionally transferring the red meat into a package having a carbon dioxide atmosphere and limited gas permeability.

3. A method to inhibit discoloration of red meat, which method comprises
(a) contacting the red meat with an inert gas atmosphere for a period of time sufficient to deoxygenate the red meat,
(b) placing the meat in a carbon dioxide atmosphere; and
(c) optionally transferring the red meat into a package having a carbon dioxide atmosphere and limited oxygen permeability.

4. A method to inhibit discoloration of red meat, which method comprises:
placing a case ready package having red meat into an inert gas atmosphere, wherein case ready package comprises a gas permeable material, and wherein the case ready package is in the inert gas atmosphere for a sufficient amount of time to allow deoxygenation of the red meat;
placing the deoxygenated case ready package in a carbon dioxide atmosphere;
transporting and/or storing the case ready package in a carbon dioxide atmosphere;
optionally removing the case ready package from the carbon dioxide atmosphere allowing for the blooming of the red meat color in air.

5. An improved process for preparing animal red meat which comprises at least the steps of slaughtering and butchering and optionally further processing the meat so as to be in a form suitable for storing and/or transporting in either bulk quantities or individual case ready packages wherein the improvement comprises
(a) contacting the red meat in a nitrogen atmosphere for a sufficient amount of time to deoxygenate during any of the steps of the process as described above;
(b) contacting the red meat with a carbon dioxide atmosphere containing a sufficient amount of carbon dioxide under conditions wherein the discoloration of the red meat is inhibited; and
(c) sealing the meat in a package that has a carbon dioxide atmosphere and limited oxygen permeability.

6. An improved process for preparing animal red meat which comprises at least the steps of slaughtering and butchering and optionally further processing the meat so as to be in a form suitable for storing and/or transporting in either bulk quantities or individual case ready packages, wherein the improvement comprises
(a) deoxygenating the meat during at least one step in the process in a nitrogen atmosphere until the oxygen level is no more than about 5% v/v;
(b) replacing at least a portion of the nitrogen with carbon dioxide;
(c) sealing the meat in a package having limited oxygen permeability;
(d) storing or transporting the meat in the package; and
(e) optionally controlling the amount of oxygen in the sealed meat during storage and/or transportation.

7. A stabilized red meat which is maintained in a sealed container comprising an atmosphere comprising carbon dioxide and no more than about 1% oxygen.

8. The red meat of claim 7, wherein the atmosphere comprises no more than about 1500 ppm oxygen.

9. The red meat of claim 7, wherein said red meat has a fresh appearance when exposed to ambient atmosphere.
